(19) United States
(12) Patent Application Publication
(10) Pub. No.: US 2014/0263312 A1
(43) Pub. Date: Sep. 18, 2014

(54) FUEL THEFT PREVENTION DEVICE FOR AUTOMOBILE

(71) Applicant: FTS CO., LTD., Toyota (JP)

(72) Inventor: SYUMEI FUJITA, Toyota (JP)

(73) Assignee: FTS CO., LTD., Toyota (JP)

(21) Appl. No.: 14/206,878

(22) Filed: Mar. 12, 2014

(30) Foreign Application Priority Data
Mar. 14, 2013 (JP) 2013-051587

(51) Int. Cl. B60K 15/04

(52) U.S. Cl. CPC B60K 15/0403
USPC 220/86.3

(57) ABSTRACT

A fuel theft prevention device for an automobile, which is capable of preventing extraction of fuel from a fuel tank using a fuel extraction hose. In the fuel theft prevention device, a hose intrusion prevention member is attached inside a filler pipe, and the hose intrusion prevention member has an attaching section, an intrusion preventing section and a connecting section. The intrusion preventing section has a plurality of end parts, each being brought into contact with or close to an interior surface of the filler pipe, and a plurality of holding parts adapted to hold the end parts and connect the end parts and an end of the connecting section to each other, and the intrusion preventing section is attached in a prescribed position inside the filler pipe.

### CROSS-REFERENCE TO RELATED APPLICATIONS

This application is related to and claims priority from Japanese patent application No. 2013-051587 incorporated herein by reference.

### BACKGROUND OF THE INVENTION

1. Field of the Invention

The present invention relates to a fuel theft prevention device for an automobile, which is adapted to prevent extraction of fuel from a fuel tank with an extraction hose.

2. Description of Related Art

Fuel such as gasoline, etc. may be extracted from a fuel tank by inserting an extraction hose into a filler pipe from a filler port of an automobile during parking. In order to prevent such extraction of fuel, in one example shown in FIG. 1, a filler pipe 10 is bent for making an inlet port 12 of a fuel tank 14 invisible from a filler port 16 of an automobile body, and a tongue-shaped hose intrusion prevention member 18 adapted to prevent intrusion of an extraction hose 20 is provided in a joint between an end of the filler pipe 10 and the inlet port 12 of the fuel tank 14 (See Japanese Unexamined Patent Application Publication No. 2005-206117, for example.).

In another example shown in FIG. 2, a hose intrusion prevention member 22 composed of a plurality of baffle plates 24 is provided inside an oil feed pipe 26 of a fuel tank 28 in a joint between the oil feed pipe 26 and an end of a filler pipe 30 for preventing extraction of fuel, and a short pipe member 32 is provided in an entrance of the oil feed pipe 26 for locking the hose intrusion prevention member 22 (See Japanese Unexamined Patent Application Publication No. 2006-88951, for example.).

However, in these examples, the hose intrusion prevention members 18 and 22 are provided in the vicinity of the fuel tanks 14 and 28 so that where the inlet ports of the fuel tanks 14 and 28 are provided below a liquid level of fuel inside the fuel tanks 14 and 28, and especially where fuel inside the fuel tanks 14 and 28 is in a so-called filled up state, the liquid level of fuel inside the filler pipes 10 and 30 becomes higher than the hose intrusion prevention members 18 and 22 so that the fuel extraction preventing effect cannot be achieved.

### SUMMARY OF THE INVENTION

Accordingly, it is an object of the present invention to provide a fuel theft prevention device for an automobile, which is capable of preventing extraction of fuel from a fuel tank with an extraction hose, regardless of a liquid level inside the fuel tank.

According to a first aspect of the present invention, in a fuel theft prevention device for an automobile, which is adapted to prevent extraction of fuel from a fuel tank, a hose intrusion prevention member is attached inside a filler pipe adapted to connect a filler port provided in an exterior surface of an automobile body and a fuel tank to each other, the hose intrusion prevention member includes an attaching section for attaching the hose intrusion prevention member to an end of the filler pipe, an intrusion preventing section provided at an end of the hose intrusion prevention member so as to be inserted inside the filler pipe for preventing intrusion of a fuel extraction hose, and a connecting section for connecting the intrusion preventing section and the attaching section to each other, the intrusion preventing section includes a plurality of end parts provided in contact with or close to an interior surface of the filler pipe, and a plurality of holding parts adapted to hold the end parts and connect the end parts to an end of the connecting section, and the intrusion preventing section is attached in a prescribed position inside the filler pipe.

In the first aspect of the present invention, a hose intrusion prevention member is attached inside a filler pipe adapted to connect a filler port provided in an exterior surface of an automobile body and a fuel tank to each other. Therefore, when a fuel extraction hose is inserted into the filler pipe from the filler port, the hose intrusion prevention member can prevent the fuel extraction hose from reaching an oil level of fuel.

The hose intrusion prevention member includes an attaching section for attaching the hose intrusion prevention member to an end of the filler pipe, an intrusion preventing section provided at an end of the hose intrusion prevention member so as to be inserted inside the filler pipe for preventing intrusion of the fuel extraction hose, and a connecting section for connecting the intrusion preventing section and the attaching section to each other. With this arrangement, when the attaching section is attached to the end of the filler pipe, the intrusion preventing section can be located in a prescribed position inside the filler pipe by virtue of the connecting section so that the fuel extraction hose cannot reach the liquid level of fuel inside the filler pipe, thereby preventing extraction of the fuel from the fuel tank.

The intrusion preventing section includes a plurality of end parts provided in contact with or close to an interior surface of the filler pipe, and holding parts adapted to hold the end parts and connect the end parts to an end of the connecting section, and the intrusion preventing section is attached in a prescribed position inside the filler pipe. Therefore, in the portion where the intrusion preventing section is located, each end part eliminates or minimizes a gap against the interior surface of the filler pipe, and since a plurality of end parts and a plurality of holding parts are provided, the fuel extraction hose does not reach the liquid level of fuel after passing between the end parts and the filler pipe, and between adjacent end parts.

According to a second aspect of the present invention, the filler pipe has a bending part, and the connecting section of the hose intrusion prevention member is composed of a material having such flexibility as to bend according to the bending of the filler pipe and such rigidity as to hold the intrusion preventing section in a prescribed position.

In the second aspect of the present invention, the filler pipe has a bending part, and the connecting section of the hose intrusion prevention member is composed of a material having such flexibility as to bend according to the bending of the filler pipe and such rigidity as to hold the intrusion preventing section in a prescribed position. Therefore, the connecting section flexes according to the bending of the filler pipe so that the intrusion preventing section of the hose intrusion prevention member can be located in a prescribed position inside the filler pipe, and consequently, intrusion of the fuel extraction hose into the filler pipe can be securely prevented with the intrusion preventing section.

According to a third aspect of the present invention, the prescribed position of the intrusion preventing section inside the filler pipe is located above a liquid level of fuel inside the filler pipe when fuel is injected into the fuel tank in a filled up state.

In the third aspect of the present invention, the prescribed position of the intrusion preventing section inside the filler pipe is located above a liquid level of fuel inside the filler pipe when fuel is injected into the fuel tank in a filled up state. Therefore, if fuel inside the fuel tank is in a filled up state, an end of the fuel extraction hose cannot reach the oil level of fuel so that extraction of fuel can be securely prevented.

According to a fourth aspect of the present invention, the plurality of end parts are arranged such that a pair of end parts of the are arranged in a longitudinal direction of the interior surface of the filler pipe, and the pair of end parts are arranged in a plurality of positions in a circumferential direction of the interior surface of the filler pipe in contact with or close to the interior surface of the filler pipe.

In the fourth aspect of the present invention, the plurality of end parts are arranged such that a pair of end parts are arranged in the longitudinal direction of the interior surface of the filler pipe, and the pair of end parts are arranged in a plurality of positions in the circumferential direction of the interior surface of the filler pipe in contact with or close to the interior surface of the filler pipe. Therefore, each of the pair of end parts can contact the interior surface of the filler pipe in two positions in the longitudinal direction thereof. In addition, the end parts also contact the interior surface of the filler pipe in a plurality of positions in the circumferential direction thereof. As a result, the end parts of the intrusion preventing section can be stably held over an entire circumference of the filler pipe without generating any gap, whereby intrusion of the fuel extraction hose into the filler pipe can be securely prevented with the intrusion preventing section.

According to a fifth aspect of the present invention, each of the plurality of end parts of the intrusion preventing section has a rod-shaped configuration extending in a longitudinal direction of the interior surface of the filler pipe, and the pair of end parts are arranged in a plurality of positions in the circumferential direction of the interior surface of the filler pipe in contact with or close to the interior surface of the filler pipe.

In the fifth aspect of the present invention, each of the plurality of end parts of the intrusion preventing section has a rod-shaped configuration extending in a longitudinal direction of the interior surface of the filler pipe, and the pair of end parts, each having the rod-shaped configuration, are arranged in a plurality of positions in the circumferential direction of the interior surface of the filler pipe in contact with or close to the interior surface of the filler pipe. Therefore, the end parts of the intrusion preventing section, each having a rod-shaped configuration, are held in line-contact with the interior surface of the filler pipe in the longitudinal direction thereof so as to be securely held, and are held in a plurality of positions in the circumferential direction of the interior surface of the filler pipe without generating any gap. As a result, intrusion of the fuel extraction hose into the filler pipe can be securely prevented with the intrusion preventing section.

According to a sixth aspect of the present invention, the attaching section for attaching the hose intrusion prevention member includes an attaching ring having a ring-shaped configuration and adapted to be attached to the end of the filler pipe, and ring holding parts adapted to hold the attaching ring and connect the attaching ring and an end of the connecting section to each other.

In the sixth aspect of the present invention, the attaching section of the hose intrusion prevention member includes an attaching ring having a ring-shaped configuration and adapted to be attached to the end of the filler pipe, and ring holding parts adapted to hold the attaching ring and connect the attaching ring and an end of the connecting section to each other. With this arrangement, by attaching the attaching ring to the end of the filler pipe in the circumferential direction thereof, the attaching section can be securely attached, and consequently, the hose intrusion prevention member can be securely attached inside the filler pipe, whereby the intrusion preventing section can be held in a prescribed position inside the filler pipe.

According to a seventh aspect of the present invention, the hose intrusion prevention member is composed of synthetic resins or metals.

In the seventh aspect of the present invention, since the hose intrusion prevention member is composed of synthetic resins or metals, the hose intrusion prevention member has not only oil resistance and durability but also flexibility and rigidity so that the intrusion preventing section can be held inside the bending filler pipe.

When the attaching section of the hose intrusion prevention member is attached to the end of the filler pipe, the intrusion preventing section can be located in a prescribed position inside the filler pipe so that the fuel extraction hose cannot reach the liquid level of fuel inside the filler pipe, thereby preventing extraction of fuel from the fuel tank.

In the portion where the intrusion preventing section is located, the end parts of the intrusion preventing section eliminate or minimize a gap against the interior surface of the filler pipe, and since the intrusion preventing section is provided with a plurality of end parts and a plurality of holding parts, the fuel extraction hose does not reach the liquid level of fuel after passing between the end parts and the filler pipe, and between adjacent end parts.

### BRIEF DESCRIPTION OF THE DRAWINGS

FIG. 1 is a sectional view of a conventional fuel tank wherein a hose intrusion prevention member is attached to a filler tube;

FIG. 2 is a sectional view of another conventional fuel tank wherein a hose intrusion prevention member is attached to a filler tube;

FIG. 3 is a sectional view of one embodiment of the present invention, wherein a hose intrusion prevention member is attached to a filler pipe of a fuel tank;

FIG. 4 is a perspective view of one embodiment of the present invention, which is seen obliquely downward, and wherein a filler pipe is attached to a fuel tank;

FIG. 5 is a perspective view of a hose intrusion prevention member adapted to be used in one embodiment of the present invention, which is seen obliquely downward;

FIG. 6 is a perspective view of an intrusion preventing section of a hose intrusion prevention member adapted to be used in one embodiment of the present invention, which is seen obliquely;

FIG. 7 is a perspective view of another intrusion preventing section of a hose intrusion prevention member adapted to be used in another embodiment of the present invention, which is seen obliquely;

FIG. 8 is a sectional view of an attaching section of a hose intrusion prevention member adapted to be used in embodiments of the present invention;

FIG. 9 is a sectional view of a connecting section of a hose intrusion prevention member adapted to be used in embodiments of the present invention;

FIG. 10 is a sectional view of another connecting section of a hose intrusion prevention member adapted to be used in embodiments of the present invention; and

FIG. 11 is a sectional view of still another connecting section of a hose intrusion prevention member adapted to be used in embodiments of the present invention.

### DETAILED DESCRIPTION OF THE PREFERRED EMBODIMENTS

The present invention relates to a fuel theft prevention device for an automobile, which is provided with a hose intrusion prevention member attached to a filler pipe adapted to be attached to a fuel tank.

Embodiments of the present invention will be explained with reference to FIG. 3 through FIG. 9.

As shown in FIG. 3 and FIG. 4, a filler hose 34 and a filler pipe 36 are attached to a fuel tank 38 for supplying fuel to the fuel tank 38 from a filler port 40 provided in an exterior surface of an automobile body.

The filler pipe 36 is composed of metals or hard synthetic resins, one end of the filler pipe 36 is connected to the filler port 40 formed in the exterior surface of the automobile body, whereas the other end thereof is connected to the filler hose 34.

The filler hose 34 is composed of rubbers or synthetic resins, each having fuel oil resistance and elastic property, and connects an inlet port 42 of the fuel tank 38 and the filler pipe 36 to each other. With this arrangement, vibrations in the fuel tank 38 and the filler pipe 36 can be absorbed, and the inlet port 42 and the filler pipe 36 can be readily assembled.

As shown in FIG. 4, the filler pipe 36 is formed to bend in conformity with the configuration of the automobile body. As shown in FIG. 3, when a fuel 44 inside the fuel tank 38 is in a filled up state, a lower end of the filler pipe 36 along with the filler hose 34 are located below a liquid level 46 of the fuel 44 depending on the attaching position of the fuel tank 38. Therefore, when the fuel 44 is in a filled up state inside the fuel tank 38, the fuel 44 enters even in an interior of a lower part of the filler pipe 36.

Reference numeral 48 designates a liquid level of fuel entering the interior of the lower part of the filler pipe 36 when the fuel 44 is in a filled up state inside the fuel tank 38.

And, as shown in FIG. 4, a fuel transfer hose 50 adapted to transfer fuel to an engine, etc., a breather hose and a cut off valve adapted to release a gas from an interior of the fuel tank 38 to an exterior thereof during fuel supply, can be provided in an upper portion of the fuel tank 38. In order to decrease an attaching space for the fuel tank 38, the number of projections is reduced on an outer surface of the fuel tank 38, and the inlet port 42 of the fuel tank 38 is provided in a side surface of the fuel tank 38.

Next, a hose intrusion prevention member 52 will be explained with reference to FIG. 5. The hose intrusion prevention member 52 includes an intrusion preventing section 54 provided at an end thereof for preventing intrusion of a fuel extraction hose 56, an attaching section 58 for attaching the hose intrusion prevention member 52 to an end of the filler pipe 36, and a connecting section 60 for connecting a center of the intrusion preventing section 54 and a center of the attaching section 58 to each other.

As shown in FIG. 5 and FIG. 6, the intrusion preventing section 54 includes end parts 62 and holding parts 64 for holding the end parts 62 at ends thereof. Each end part 62 and each holding part 64 are integrally formed into a rod-shaped configuration such that a plurality of these rod-shaped end parts 62 and holding parts 64 are attached to the connecting section 60 in contact with or close to the interior surface of the filler pipe 36 to prevent intrusion of the fuel extraction hose 56.

When the hose intrusion prevention member 52 is attached to the filler pipe 36, the end parts 62 of the intrusion preventing section 54 are located in contact with or close to the interior surface of the filler pipe 36, and a plurality of holding parts 64 of the intrusion preventing section 54 are provided in the interior surface of the filler pipe 36 in a circumferential direction thereof. Therefore, no gap is defined between the interior surface of the filler pipe 36 and the end parts 62, and between adjacent holding parts 64 so that intrusion of the fuel extraction hose 56 can be prevented.

FIG. 6 shows another embodiment of an intrusion preventing section. In an intrusion preventing section 66, a pair of end parts 68 are arranged in a longitudinal direction of the interior of the filler pipe 36, and a plurality of these end parts 68 are arranged in a circumferential direction of the filler pipe 36 so as to be uniformly located on the interior surface of the filler pipe 36.

Since a pair of the end parts 68 are arranged in the longitudinal direction of the interior surface of the filler pipe 36, they are held in two positions in the longitudinal direction of the filler pipe 36 so as to be stably held. In addition, since a pair of the end parts 68 and a pair of holding parts 70 are uniformly arranged in a plurality of positions uniformly in the circumferential direction of the filler pipe 36, the holding parts 70 can prevent intrusion of the fuel extraction hose 56. The number of the end parts 68 and the holding parts 70 may be the number capable of preventing intrusion of the fuel extraction hose 56. If the number thereof increases excessively, the flow of fuel becomes worse upon injecting fuel into the fuel tank.

The intrusion preventing section can have a construction shown in FIG. 7. In an intrusion preventing section 72 in FIG. 7, a plurality of end parts 74 are respectively formed into a rod-shaped configuration extending in the longitudinal direction of the interior surface of the filler pipe 36, and these end parts 74 and holding parts 76 are arranged uniformly in a plurality of positions in a circumferential direction of the filler pipe 36 in contact with or close to the interior surface of the filler pipe 36.

With this arrangement, the rod-shaped end parts 74 extending in the longitudinal direction of the interior surface of the filler pipe 36 are brought into line contact with the interior surface of the filler pipe 36 in the longitudinal direction thereof so that the end parts 74 are stably held in the longitudinal direction of the filler pipe 36. In addition, since the end parts 74 and the holding parts 76 are arranged uniformly in the circumferential direction of the filler pipe 36, the end parts 74 can prevent intrusion of the fuel extraction hose 56. The number of the end parts 74 and the holding parts 76 may be the number capable of preventing intrusion of the fuel extraction hose 56. If the number thereof increases excessively, the flow of fuel becomes worse upon injecting fuel into the fuel tank.

Next, the attaching section 58 will be explained with reference to FIG. 5 and FIG. 8. As shown in FIG. 5, the attaching section 58 includes an attaching ring 78 having a ring-shaped configuration, and ring holding parts 80 adapted to attach the attaching ring 78 to a rear end of the connecting section 60

When the attaching ring 78 is attached to a connecting port 82 of the filler pipe 36, an end of the connecting port 82 is fitted in a recessed part 84 provided in the attaching ring 78. Therefore, the attaching ring 78 is attached to the connecting port 82 of the filler pipe 36 over the entire circumference thereof so that the hose intrusion prevention member 54 (66, 72) can be held in a prescribed position inside the filler pipe 36.

Furthermore, the number of the ring holding parts 80 can be determined to such a number as not to obstruct the flow of fuel, and in the present embodiment, three ring holding parts 80 are used.

Next, the connecting section 60 will be explained with reference to FIG. 5, FIG. 9 through FIG. 11. The connecting section 60 is formed into a long rod-shaped configuration so as to connect the intrusion preventing section 54 and the attaching section 58 to each other. The connecting section 60 is formed so as to flexibly bend according to the bending of the filler pipe 36 when inserted into the filler pipe 36. And, the connecting section 60 has rigidity so as to locate the intrusion preventing section 54 in a prescribed position that is above the liquid level 48 of fuel entering the lower portion of the filler pipe 36 when the fuel 44 inside the fuel tank 38 is in a filled up state.

The sectional shape of the connecting section 60 can be selected among various sectional shapes such as a T-shaped sectional shape shown in FIG. 9, an H-shaped sectional shape shown in FIG. 10, and a circular sectional shape shown in FIG. 11, considering the flexibility and rigidity of the connecting section 60. In the case of the T-shaped sectional shape, rigidity of the connecting section 60 is excellent, and the fuel flow resistance is small, in the case of the H-shaped sectional shape, rigidity is excellent, and in the case of the circular sectional shape, the flexibility and the fuel flow resistance is small.

The hose intrusion prevention member 52 can be composed of synthetic resins or metals. In this case, the hose intrusion prevention member 52 has oil resistance and durability, and materials having flexibility and rigidity can be selected. As a result, the intrusion preventing section can be held inside the bent filler pipe 36.

Where the hose intrusion prevention member 52 is composed of synthetic resins, a high density polyethylene (HDPE), nylon, polyacetal, etc. can be used considering the oil resistance, rigidity, etc. And where the hose intrusion prevention member 52 is composed of metals, stainless steel, etc. can be used.

While the invention has been described in connection with what are considered to be the preferred embodiments, it is to be understood that the invention is not limited to the disclosed embodiments, but, on the contrary, is intended to cover various modifications and equivalent arrangements included within the spirit and scope of the appended claims.

What is claimed is:

1. A fuel theft prevention device for an automobile, which is adapted to prevent extraction of fuel from a fuel tank, comprising:
a hose intrusion prevention member attached inside a filler pipe adapted to connect a filler port provided in an exterior surface of an automobile body and the fuel tank to each other, wherein
said hose intrusion prevention member includes an attaching section for attaching said hose intrusion prevention member to an end of said filler pipe, an intrusion preventing section provided at an end of said hose intrusion prevention member so as to be inserted inside said filler pipe for preventing intrusion of a fuel extraction hose, and a connecting section for connecting said intrusion preventing section and said attaching section to each other; and
said intrusion preventing section includes a plurality of end parts provided in contact with or close to an interior surface of said filler pipe, and a plurality of holding parts adapted to hold said end parts and connect said end parts to an end of said connecting section, said intrusion preventing section being attached in a prescribed position inside said filler pipe.

2. The fuel theft prevention device for an automobile, as claimed in claim 1, wherein said filler pipe has a bending part, said connecting section of said hose intrusion prevention member is composed of a material having such flexibility as to bend according to the bending of said filler pipe and such rigidity as to hold said intrusion preventing section in a prescribed position.

3. The fuel theft prevention device for an automobile, as claimed in claim 1, wherein said prescribed position of said intrusion preventing section inside said filler pipe is located above a liquid level of fuel inside said filler pipe when fuel is injected into said fuel tank in a filled up state.

4. The fuel theft prevention device for an automobile, as claimed in claim 1, wherein said plurality of end parts are arranged such that a pair of end parts are arranged in a longitudinal direction of said interior surface of said filler pipe, and said pair of end parts are arranged in a plurality of positions in a circumferential direction of said interior surface of said filler pipe so as to be in contact with or close to said interior surface of said filler pipe.

5. The fuel theft prevention device for an automobile, as claimed in claim 1, wherein each of said plurality of end parts has a rod-shaped configuration extending in a longitudinal direction of said interior surface of said filler pipe, and said pair of end parts are arranged in a plurality of positions in a circumferential direction of said interior surface of said filler pipe so as to be in contact or close to said interior surface of said filler pipe.

6. The fuel theft prevention device for an automobile, as claimed in claim 1, wherein said attaching section of said hose intrusion prevention member includes an attaching ring having a ring-shaped configuration and adapted to be attached to said end of said filler pipe, and ring holding parts adapted to hold said attaching ring and connect said attaching ring and an end of said connecting section to each other.

7. The fuel theft prevention device for an automobile, as claimed in claim 1, wherein said hose intrusion prevention member is composed of one of synthetic resins and metals.
